(19) United States
(12) Patent Application Publication
(10) Pub. No.: US 2007/0170343 A1
(43) Pub. Date: Jul. 26, 2007

(54) METHOD FOR MAINTAINING A LOW-PRESSURE PROCESS APPARATUS AND A TRANSPORTING DEVICE

(75) Inventor: Ting-Hui Huang, Tao Yuan Shien (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: QUANTA DISPLAY INC., Tao Yuan Shien (TW)

(21) Appl. No.: 11/464,222

(22) Filed: Aug. 14, 2006

(30) Foreign Application Priority Data
Jan. 26, 2006 (TW) 95103049

(51) Int. Cl. F16M 13/00

(52) U.S. Cl. 248/580

(57) ABSTRACT

A device for transporting a housing of a low-pressure process apparatus comprises a first air actuator, a second air actuator, at least one first sliding element, at least one second sliding element, a supporting structure and at least one connecting element. The first sliding element is disposed on the first air actuator. The second sliding element is disposed on the second air actuator. The supporting structure is disposed between the first and second air actuators. The connecting element is disposed on the supporting structure connecting to the housing.

### BACKGROUND OF THE INVENTION

1. Field of the Invention

The invention relates to a method for maintaining a low-pressure process apparatus and a transporting device, and in particular to a method for maintaining a low-pressure process apparatus for drying photoresist.

2. Description of the Related Art

FIG. 1a shows a conventional low-pressure process apparatus 10 comprising a base 1, a housing 2, a stage 3, supporting elements 5, actuating devices 6 and an exhaust pipe 7. The stage 3 is disposed on the base 1, supporting a substrate 4. The housing 2 and the base 1 form a chamber 8 receiving the stage 3 and the substrate 4. The exhaust pipe 7 and the supporting elements 5 are disposed on the base 1. The actuating devices 6 are disposed on the base 1. With reference to FIG. 1b, the actuating devices 6 push the supporting elements 5 and the housing 2, and separate the housing 2 from the base 1 allowing a robot (not shown) to access the substrate 4.

When the low-pressure process apparatus 10 dries a photoresist material (for example, resin), volatile chemicals or particles adheres to an inner wall of the housing 2 and the exhaust pipe 7. Thus, the housing 2 and the exhaust pipe 7 require regular cleaning. Conventionally, the housing 2 and the exhaust pipe 7 are manually cleaned after the housing 2 is elevated. The cleaning process is difficult and time consuming. Additionally, when the housing 2 and the exhaust pipe 7 are cleaned, the low-pressure process apparatus 10 is shut down, and process yield is decreased.

### BRIEF SUMMARY OF THE INVENTION

A detailed description is given in the following embodiments with reference to the accompanying drawings.

The invention provides a device for transporting a housing of a low-pressure process apparatus, which comprises a first air actuator, a second air actuator, at least one first sliding element, at least one second sliding element, a supporting structure and at least one connecting element. The first sliding element is disposed on the first air actuator. The second sliding element is disposed on the second air actuator. The supporting structure is disposed between the first and second air actuators. The connecting element is disposed on the supporting structure connecting to the housing.

The transporting device of the invention detaches the housing of the low-pressure process apparatus from the base to be cleaned. Thus, when the original housing (first housing) is cleaned, another housing (second housing) is disposed on the base to continue the low-pressure process. Shutdown time of the low-pressure process apparatus is thus shortened, and yield and cost are conserved.

### BRIEF DESCRIPTION OF THE DRAWINGS

The invention can be more fully understood by reading the subsequent detailed description and examples with references made to the accompanying drawings, wherein:

FIG. 1a shows a conventional low-pressure process apparatus;

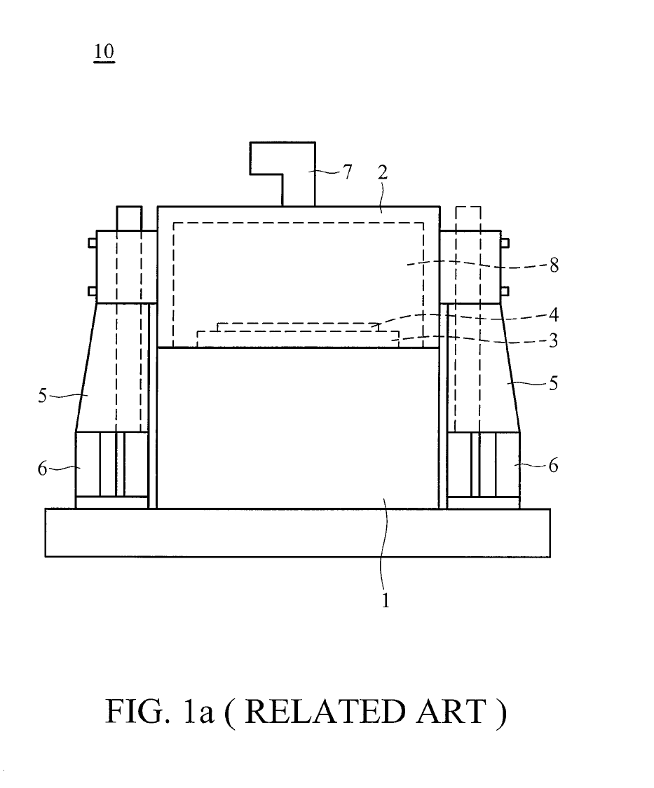

FIG. 1b shows a housing separated from a base of the conventional low-pressure process apparatus;

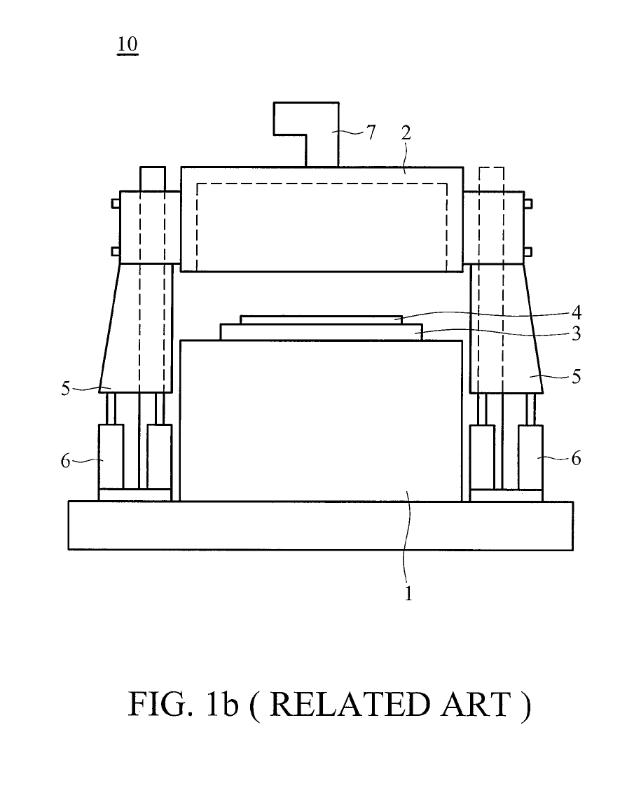

FIG. 2a shows a transporting device and a low-pressure process apparatus of the invention;

FIG. 2b shows a housing separated from a base of the low-pressure process apparatus of the invention;

FIG. 3a shows a supporting structure of the invention in a first position;

FIG. 3b shows the supporting structure of the invention in a second position to raise the housing;

FIG. 4a shows the transporting device of the invention sliding the housing in a first horizontal direction;

FIG. 4b shows the transporting device of the invention moving the housing to a stage;

FIG. 5a shows the low-pressure process apparatus of the invention disposed in substrate process equipment; and

FIG. 5b is a top view of the transporting device of the invention moving the housing in the first horizontal direction.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

The invention provides a method for transporting a housing of a low-pressure process apparatus and a transporting device thereof, whereby the housing is disassembled from a base to be cleaned.

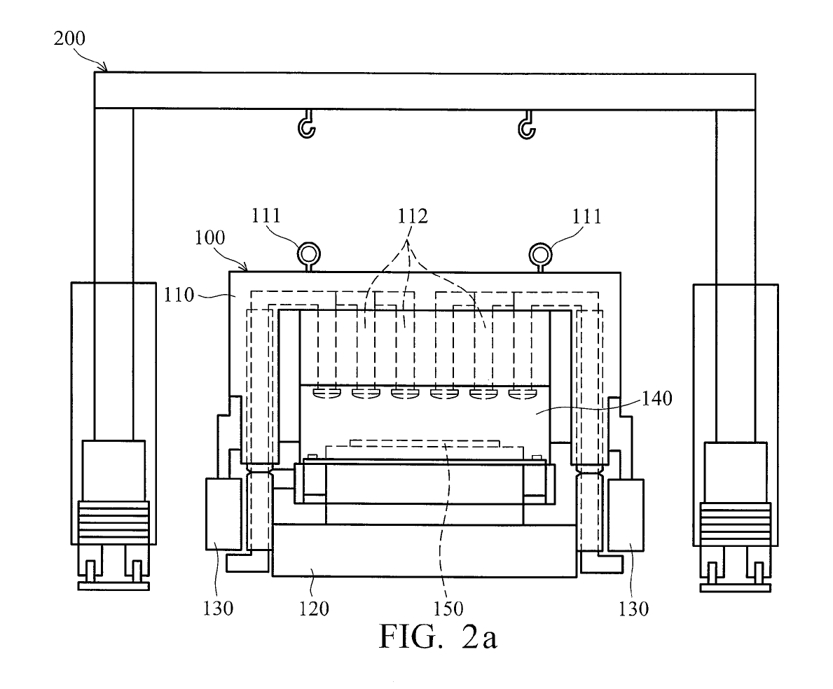

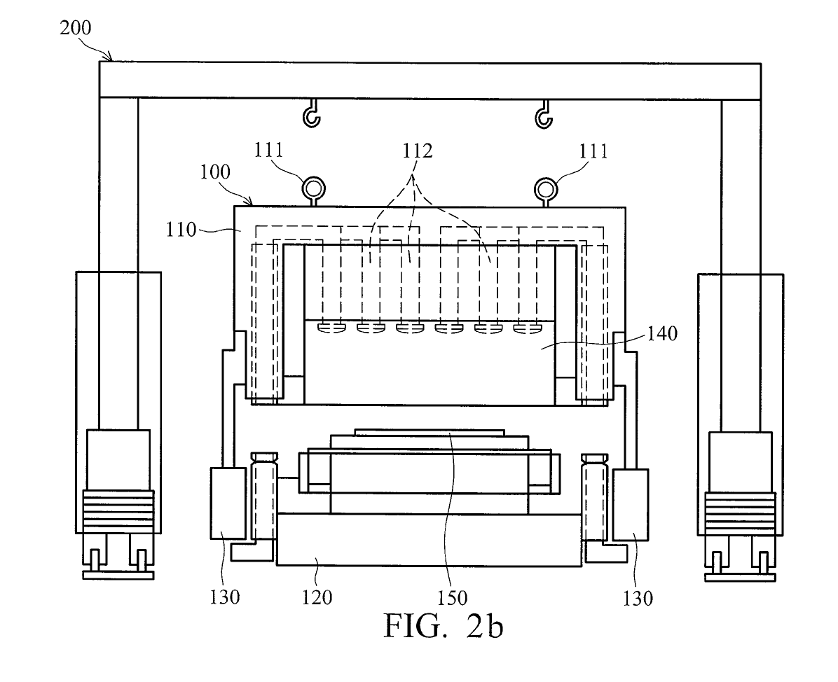

FIG. 2a shows the transporting device 200 of the invention for transporting the housing 110 of the low-pressure process apparatus 100. The low-pressure process apparatus 100 comprises a housing 110, a base 120 and two air actuators 130. Exhaust pipes 112 are disposed in the housing 110. Connection structures 111, such as ring structures, are disposed on the surface of the housing 110. When the housing 110 is disposed on the base 120, the housing 110 and the base 120 form a chamber 140 to receive and process a substrate 150.

With reference to FIG. 2b, when the low-pressure process is finished, the air actuators 130 raise and separate the housing 110 from the base 120 for allowing a robot (not shown) to access the substrate 150.

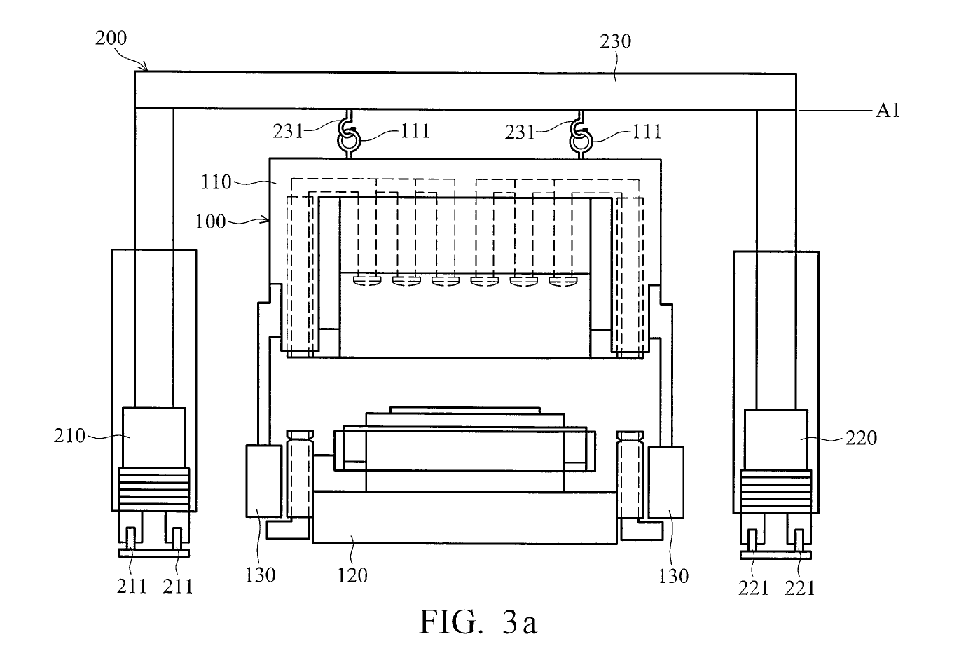

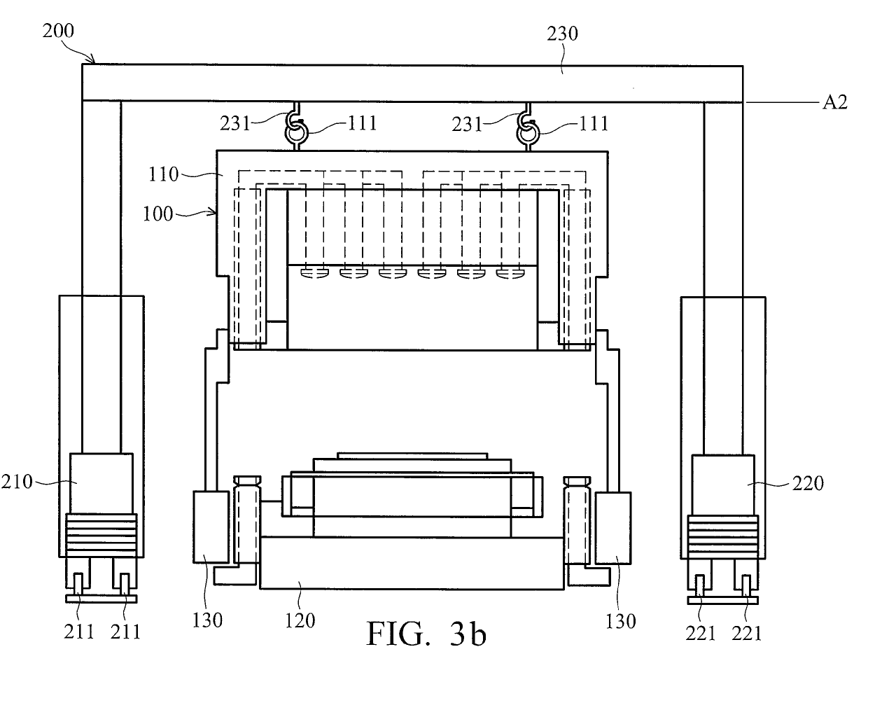

With reference to FIG. 3a, the transporting device 200 comprises a first air actuator 210, a second air actuator 220, a plurality of first sliding elements 211, a plurality of second sliding elements 221, a supporting structure 230 and a plurality of connecting elements 231. The supporting structure 230 is supported by the first air actuator 210 and second air actuator 220. The first sliding elements 211 are disposed below the first air actuator 210. The second sliding elements 221 are disposed below the second air actuator 220. The first sliding elements 211 and the second sliding elements 221 are rollers. The connecting elements 231, hooks, are disposed on the supporting structure 230. When the housing 110 is detached from the base 120 to be cleaned, the housing 110 is first raised by the air actuators 130, and the first air actuator 210 and the second air actuator 220 then lower the supporting structure 230 to a first position A1 to connect the connecting elements 231 to the connecting elements 111.

With reference to FIG. 3b, after the connecting elements 231 are connected to the connecting elements 111, the first air actuator 210 and the second air actuator 220 raise the supporting structure 230 to a second position A2. Thus, the housing 110 is separated from the air actuators 130 and the base 120.

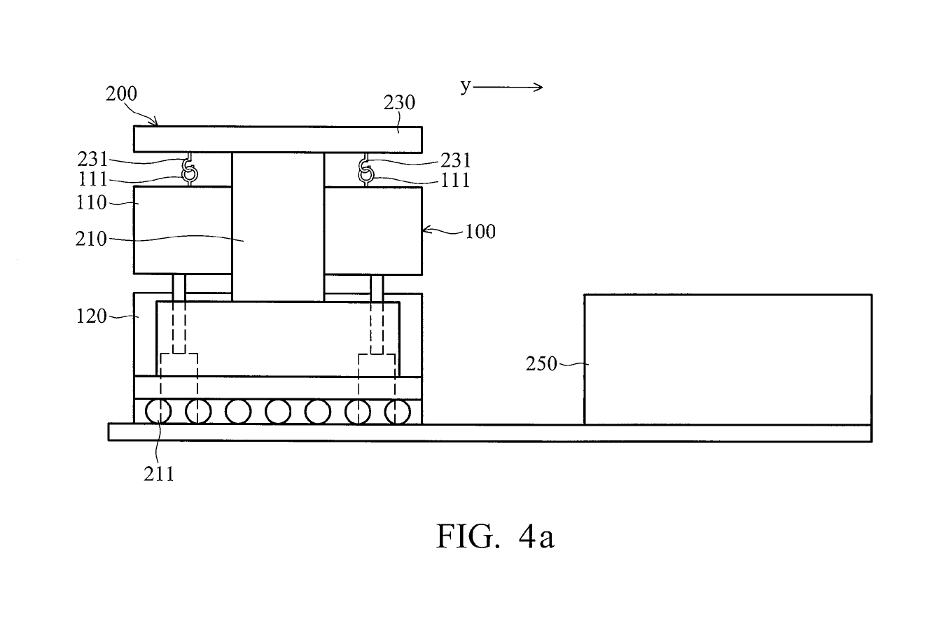

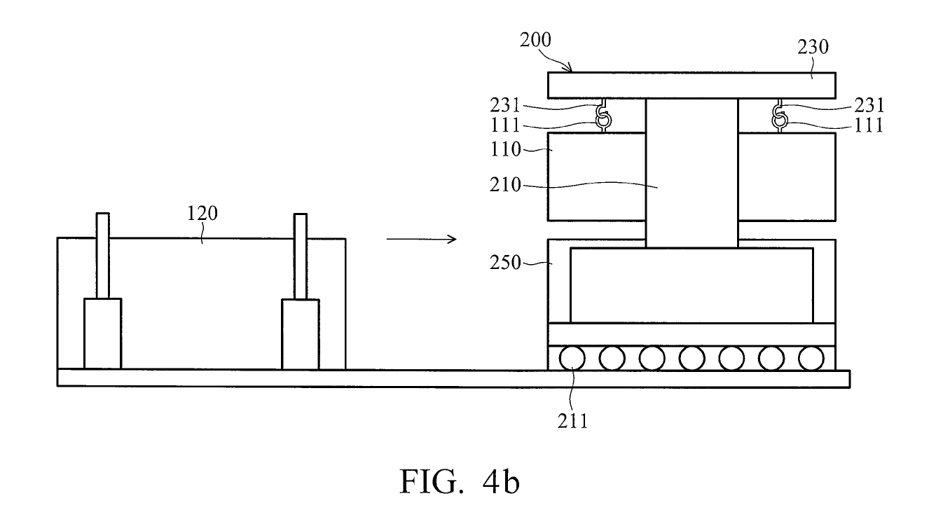

FIG. 4a is a side view of the low-pressure process apparatus 100 and the transporting device 200. After the supporting structure 230 raises the housing 110, the transporting device 200 slides in a first horizontal direction y by the sliding elements 211 and 221. Then, as shown in FIG. 4b, the transporting device 200 moves the housing 110 to a stage 250 to be cleaned and maintained.

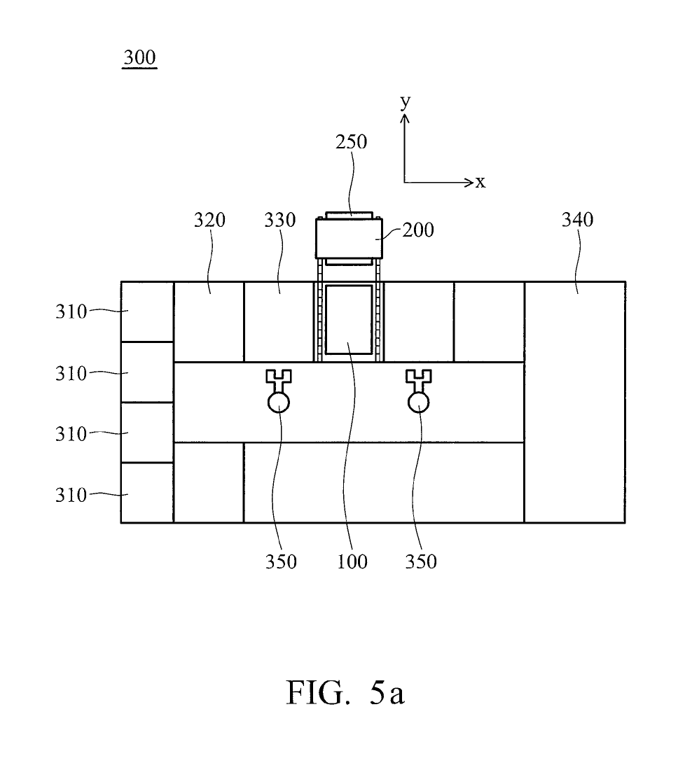

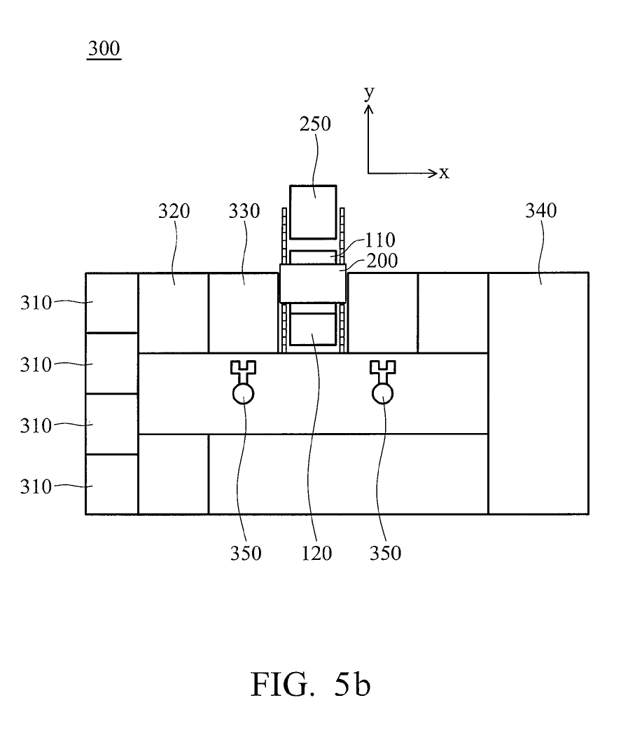

FIG. 5a shows the low-pressure process apparatus 100 disposed in a substrate process equipment 300. The substrate process equipment 300 comprises a plurality of stockers 310, a cleaning unit (first process apparatus) 320, a photoresist coating apparatus (second process apparatus) 330, the low-pressure process apparatus 100, an exposure unit 340 and robots 350, wherein the cleaning unit (first process apparatus) 320, the photoresist coating apparatus (second process apparatus) 330, and the low-pressure process apparatus 100 are arranged along a second horizontal direction x. With reference to FIG. 5b, when the housing 110 is detached, the transporting device 200 moves the housing 110 in the first horizontal direction y to the stage 250. The first horizontal direction y is perpendicular to the second horizontal direction x. In a embodiment, the low-pressure process apparatus 100 of the invention is utilized to dry organic solvents in photoresist material (such as a resin).

The transporting device 200 of the invention detaches the housing 110 of the low-pressure process apparatus 100 from the base 120 to be cleaned. Thus, when the original housing (first housing) is cleaned, another housing (second housing) can be disposed on the base 120 to continue the low-pressure process. Shutdown time of the low-pressure process apparatus is thus shortened, and yield and cost are conserved.

In a modified embodiment, the transporting device omits the second air actuator, utilizing only the first air actuator to raise the housing. In this embodiment, rigidity of the first air actuator and the supporting structure are increased.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A device for transporting a housing of a low-pressure process apparatus, comprising:
a first air actuator;
a second air actuator;
at least one first sliding element, disposed on the first air actuator;
at least one second sliding element, disposed on the second air actuator;
a supporting structure, disposed between the first and second air actuators; and
at least one connecting element, disposed on the supporting structure for connecting to the housing.

2. The device as claimed in claim 1, wherein the first sliding element is a roller.

3. The device as claimed in claim 1, wherein the second sliding element is a roller.

4. The device as claimed in claim 1, wherein the first sliding element is disposed below the first air actuator.

5. The device as claimed in claim 1, wherein the second sliding element is disposed below the second air actuator.

6. The device as claimed in claim 1, wherein the first and second air actuators move the supporting structure between a first position and a second position.

7. The device as claimed in claim 1, wherein the connecting element is a hook.

8. A method for maintaining a low-pressure process apparatus, comprising:
providing a device as claimed in claim 1;
connecting the connecting element to the housing;
raising the supporting structure from a first position to a second position by the first and second air actuators thereby raising the housing from the low-pressure process apparatus; and
sliding the device in a first horizontal direction to move the housing to a maintaining stage.

9. The method as claimed in claim 8, wherein the low-pressure process apparatus, a first process apparatus and a second process apparatus are aligned in a second horizontal direction, and the first horizontal direction is perpendicular to the second horizontal direction.

10. A transporting device, comprising:
a first air actuator;
at least one first sliding element, disposed on the first air actuator;
a supporting structure, disposed on the first air actuator; and
at least one connecting element, disposed on the supporting structure.

11. The device as claimed in claim 10, wherein the first sliding element is a roller.

12. The device as claimed in claim 10, wherein the first sliding element is disposed below the first air actuator.

13. The device as claimed in claim 10, wherein the first air actuator moves the supporting structure between a first position and a second position.

14. The device as claimed in claim 10, wherein the connecting element is a hook.
